(19) United States
(12) Patent Application Publication
(10) Pub. No.: US 2018/0090814 A1
(43) Pub. Date: Mar. 29, 2018

(54) Phased Array Antenna Panel Having Cavities with RF Shields for Antenna Probes

(71) Applicant: Movandi Corporation, Newport Beach, CA (US)

(72) Inventors: Seunghwan Yoon, Irvine, CA (US); Alfred Grau BesoIi, Irvine, CA (US); Maryam Rofougaran, Rancho Palos Verdes, CA (US); Farid Shirinfar, Granada Hills, CA (US); Sam Gharavi, Irvine, CA (US); Michael Boers, South Turramurra (AU); Ahmadreza Rofougaran, Newport Coast, CA (US)

(73) Assignee: Movandi Corporation

(21) Appl. No.: 15/279,171

(22) Filed: Sep. 28, 2016

(51) Int. Cl. H01Q 1/22; H01Q 21/00; H01Q 1/52

(52) U.S. Cl. CPC H01Q 1/2283; H01Q 1/526; H01Q 21/0025

(57) ABSTRACT

A phased array antenna panel includes a substrate over a metallic base, a cavity in the substrate and the metallic base, a plurality of antenna probes situated over the cavity, where the plurality of antenna probes are separated by a plurality of RF shields. The plurality of RF shields are configured to reduce coupling between the plurality of antenna probes. The plurality of antenna probes include a pair of antenna probes, where some of the plurality of RF shields are parallel to a horizontal-polarization antenna probe of the pair of antenna probes, and some of the plurality of RF shields are parallel to a vertical-polarization antenna probe of the pair of antenna probes. The horizontal-polarization antenna probe is perpendicular to a vertical-polarization antenna probe.

### RELATED APPLICATION(S)

The present application is related to U.S. patent application Ser. No. 15/225,071, filed on Aug. 1, 2016, Attorney Docket Number 0640101, and titled “Wireless Receiver with Axial Ratio and Cross-Polarization Calibration,” and U.S. patent application Ser. No. 15/225,523, filed on Aug. 1, 2016, Attorney Docket Number 0640102, and titled “Wireless Receiver with Tracking Using Location, Heading, and Motion Sensors and Adaptive Power Detection,” and U.S. patent application Ser. No. 15/226,785, filed on Aug. 2, 2016, Attorney Docket Number 0640103, and titled “Large Scale Integration and Control of Antennas with Master Chip and Front End Chips on a Single Antenna Panel,” and U.S. patent application Ser. No. 15/255,656, filed on Sep. 2, 2016, Attorney Docket No. 0640105, and titled “Novel Antenna Arrangements and Routing Configurations in Large Scale Integration of Antennas with Front End Chips in a Wireless Receiver,” and U.S. patent application Ser. No. 15/256,038 filed on Sep. 2, 2016, Attorney Docket No. 0640106, and titled “Transceiver Using Novel Phased Array Antenna Panel for Concurrently Transmitting and Receiving Wireless Signals,” and U.S. patent application Ser. No. 15/256,222 filed on Sep. 2, 2016, Attorney Docket No. 0640107, and titled “Wireless Transceiver Having Receive Antennas and Transmit Antennas with Orthogonal Polarizations in a Phased Array Antenna Panel,” and U.S. patent application Ser. No. 15/278,970 filed on Sep. 28, 2016, Attorney Docket No. 0640108, and titled “Low-Cost and Low-Loss Phased Array Antenna Panel.” The disclosures of all of these related applications are hereby incorporated fully by reference into the present application.

### BACKGROUND

The next generation wireless communication networks may adopt very high frequency signals in the millimeter-wave range to deliver faster Internet speed and handle surging mobile network traffic. Thus, millimeter-wave antennas may be a crucial part of the next generation wireless communications system. Due to the small sizes of millimeter-wave antennas, during transmission and reception operations, signal coupling may occur among antenna probes as well as among many individual millimeter-wave antennas in an antenna panel. Signal coupling may lead to interference and result in undesirable beam patterns and reduced gain.

Accordingly, there is a need in the art for improving the performance of millimeter-wave antennas by reducing loss, and improving signal isolation, bandwidth, gain, directivity and radiation pattern.

### SUMMARY

The present disclosure is directed to a phased array antenna panel having cavities with radio frequency (RF) shields for antenna probes, substantially as shown in and/or described in connection with at least one of the figures, and as set forth in the claims.

### BRIEF DESCRIPTION OF THE DRAWINGS

FIG. 1A illustrates a perspective view of a portion of a phased array antenna panel according to one implementation of the present application.

FIG. 1B illustrates a perspective view of a portion of a phased array antenna panel according to one implementation of the present application.

FIG. 2 illustrates a functional block diagram of a radio frequency front end circuit of a semiconductor die according to one implementation of the present application.

FIG. 3A illustrates a perspective view of a cavity of a phased array antenna panel according to one implementation of the present application.

FIG. 3B illustrates a perspective view of a cavity of a phased array antenna panel according to one implementation of the present application.

FIG. 4A illustrates a top plan view of a cavity of a phased array antenna panel according to one implementation of the present application.

FIG. 4B illustrates a top plan view of a cavity of a phased array antenna panel according to one implementation of the present application.

FIG. 5A illustrates a perspective view of a cavity of a phased array antenna panel according to one implementation of the present application.

FIG. 5B illustrates a perspective view of a cavity of a phased array antenna panel according to one implementation of the present application.

FIG. 6A illustrates a top plan view of a cavity of a phased array antenna panel according to one implementation of the present application.

FIG. 6B illustrates a top plan view of a cavity of a phased array antenna panel according to one implementation of the present application.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

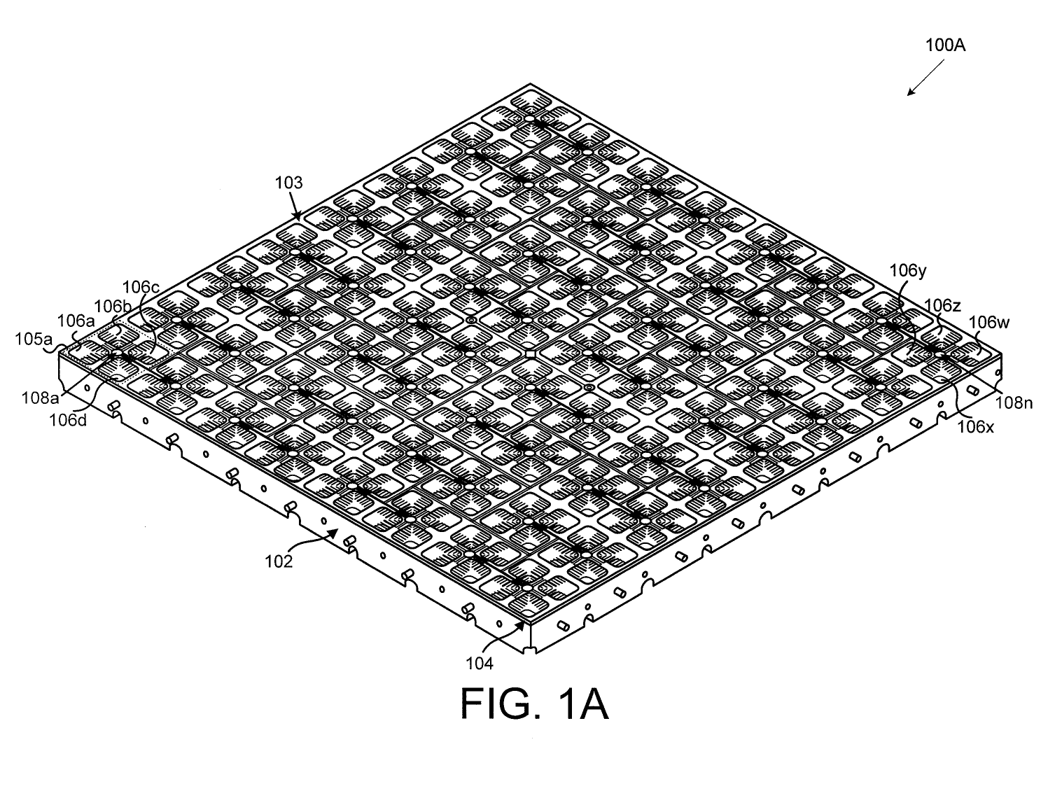

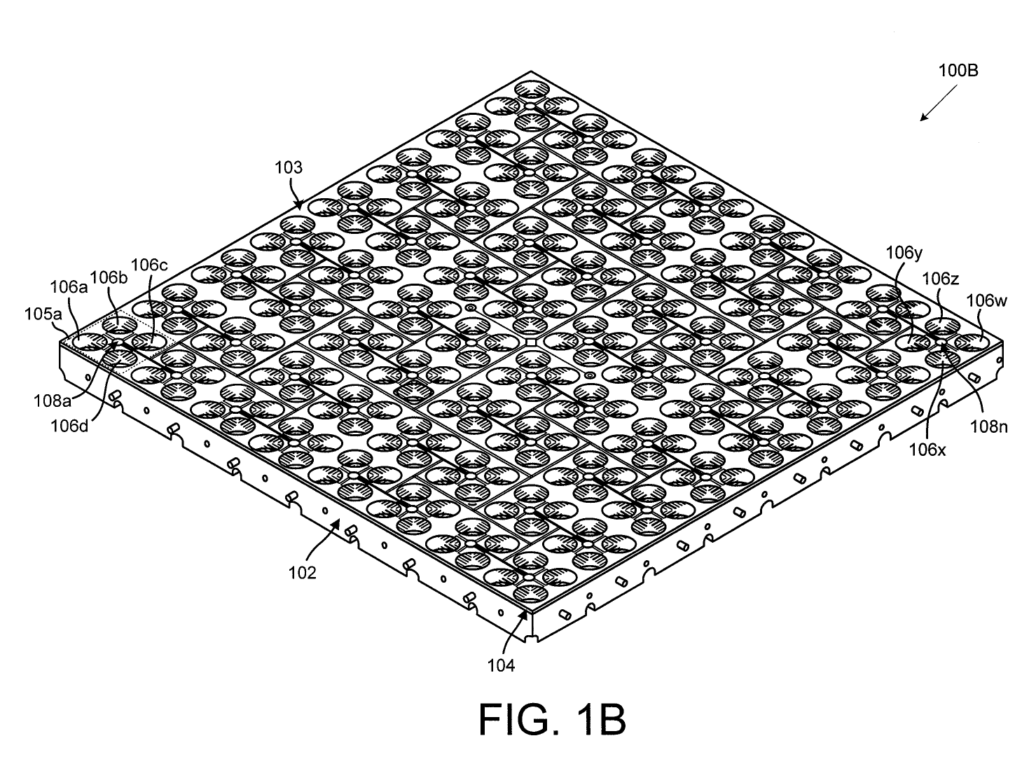

FIG. 1A illustrates a perspective view of a portion of a phased array antenna panel according to one implementation of the present application. As shown in FIG. 1A, phased array antenna panel 100A includes metallic base 102, substrate 104, a plurality of cavities such as cavities 106a, 106b, 106c, 106d, 106w, 106x, 106y and 106z (hereinafter collectively referred to as cavities 106), and a plurality of semiconductor dies such as semiconductor dies 108a and 108n (hereinafter collectively referred to as semiconductor dies 108).

As illustrated in FIG. 1A, substrate 104 is situated over metallic base 102. Semiconductor dies 108 are situated over substrate 104. Cavities 106 extend through substrate 104 into metallic base 102. The formation of cavities 106 through substrate 104 into metallic base 102 creates ridges on top side 103 of phased array antenna panel 100A, where the ridges form a grid pattern. Semiconductor dies 108 are situated on and supported by the intersections of the ridges, and coupled to a group of neighboring cavities. For example, semiconductor die 108a is coupled to each of cavities 106a, 106b, 106c and 106d, while semiconductor die 108n is coupled to each of cavities 106w, 106x, 106y and 106z.

In the present implementation, metallic base 102 includes aluminum or aluminum alloy. In another implementation, metallic base 102 may include copper or other suitable metallic material. In the present implementation, substrate 104 is a low-cost substrate, such as a printed circuit/wiring board with conductive traces formed therein. In one implementation, substrate 104 may include FR-4 material, which is low cost and can deliver robust performance and durability. In one implementation, substrate 104 may include conductive traces that carry signals from each of semiconductor dies 108 to a master chip (not explicitly shown in FIG. 1A), for example. In the present implementation, each of cavities 106 has a rectangular cuboid shape with a substantially square opening on top side 103 of phased array antenna panel 100A. In the present implementation, cavities 106 are air cavities, as air has a low dielectric constant and is an excellent dielectric material for radio frequency antenna applications. In another implementation, cavities 106 may be filled with other suitable dielectric material with a low dielectric constant. Each of cavities 106 may include a plurality of antenna probes that extend over the cavity and are separated by a plurality of radio frequency (RF) shields to reduce coupling between the plurality of antenna probes.

In the present implementation, each of cavities 106 includes a pair of antenna probes, such as a horizontal-polarization antenna probe and a vertical-polarization antenna probe, which are separated by a plurality of RF shields to reduce interference from RF transmissions and/or receptions between the two antenna probes.

As illustrated in FIG. 1A, each pair of antenna probes extends over a corresponding one of cavities 106 and is electrically coupled to a corresponding one of semiconductor dies 108 through electrical connectors, such as microstrip feed lines, on substrate 104. As such, each of semiconductor dies 108 is electrically coupled to four pairs of antenna probes, each extending over one of four neighboring cavities. As illustrated in FIG. 1A, a plurality of RF shields also extend over a corresponding one of cavities 106 and separates a corresponding pair of antenna probes. The plurality of RF shields are configured to reduce electromagnetic interference between signals to be transmitted and/or received by a horizontal-polarization antenna probe and a vertical-polarization antenna probe, for example.

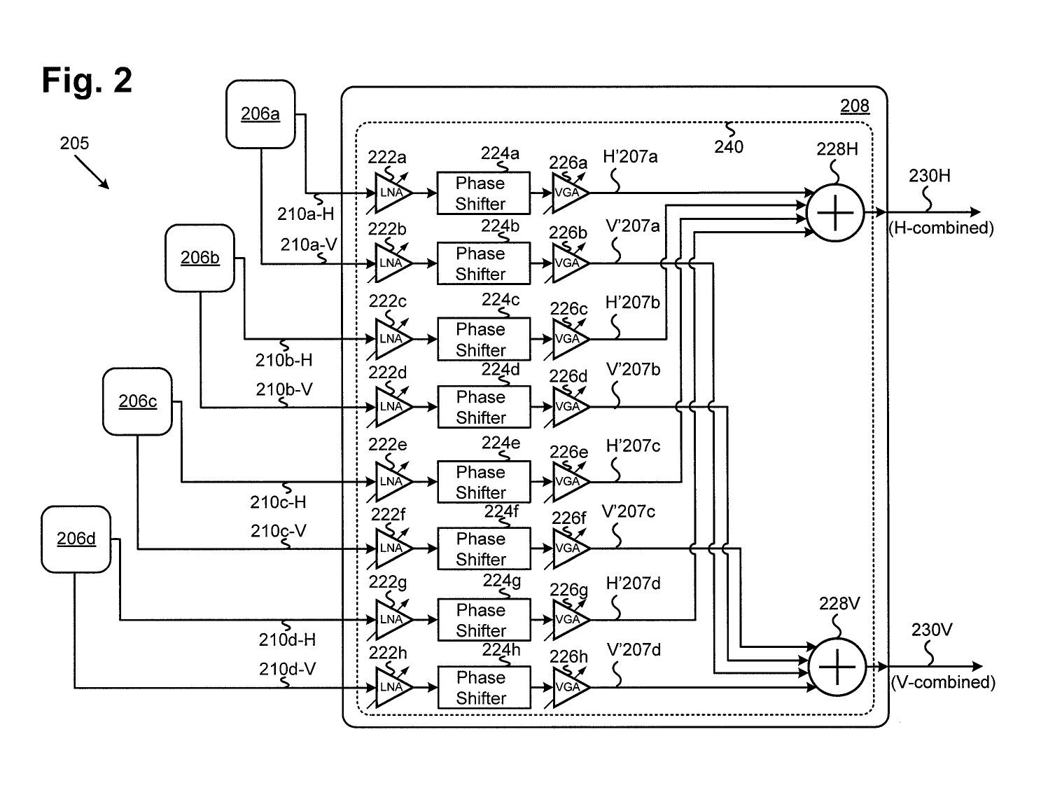

In the present implementation, each of semiconductor dies 108 is electrically coupled to four pairs of antenna probes, where each pair of antenna probes extends over a corresponding one of four neighboring cavities. The four pairs of antenna probes are electrically coupled to a radio frequency (RF) front end circuit (not explicitly shown in FIG. 1A) integrated in each of a corresponding one of semiconductor dies 108. In one implementation, the RF front end circuit is configured to receive RF signals from the group of neighboring cavities through the corresponding pairs of antenna probes, amplify the RF signals, reduce signal noise, adjust the phase of the RF signals, and combine the RF signals, for example. Some relevant details of semiconductor dies 108 are discussed with reference to FIG. 2.

FIG. 1B illustrates a perspective view of a portion of a phased array antenna panel according to one implementation of the present application. As illustrated in FIG. 1B, phased array antenna panel 100B includes metallic base 102, substrate 104, a plurality of cavities such as cavities 106a, 106b, 106c, 106d, 106w, 106x, 106y and 106z (hereinafter collectively referred to as cavities 106), and a plurality of semiconductor dies such as semiconductor dies 108a and 108n (hereinafter collectively referred to as semiconductor dies 108). In the present implantation, metallic base 102, substrate 104, and semiconductor dies 108 in FIG. 1B may substantially correspond to metallic base 102, substrate 104, and semiconductor dies 108, respectively, of phased array antenna panel 100A in FIG. 1A. In contrast to cavities 106 in FIG. 1A each having a rectangular cuboid shape with a substantially square opening on top side 103 of phased array antenna panel 100A, as shown in FIG. 1B, each of cavities 106 is in a cylindrical shape with a substantially circular opening on top side 103 of phased array antenna panel 100B.

As illustrated in FIG. 1B, each of cavities 106 includes a pair of antenna probes, such as a horizontal-polarization antenna probe and a vertical-polarization antenna probe, which are separated by a plurality of RF shields to reduce interference from RF transmissions and/or receptions between the two antenna probes. As illustrated in FIG. 1B, each pair of antenna probes extends over a corresponding one of cavities 106 and is electrically coupled to a corresponding one of semiconductor dies 108 through electrical connectors, such as microstrip feed lines, on substrate 104. As such, each of semiconductor dies 108 is electrically coupled to four pairs of antenna probes, each extending over one of four neighboring cavities. As illustrated in FIG. 1B, a plurality of RF shields also extend over a corresponding one of cavities 106 and separates a corresponding pair of antenna probes. The plurality of RF shields are configured to reduce electromagnetic interference between signals to be transmitted and/or received by a horizontal-polarization antenna probe and a vertical-polarization antenna probe, for example.

FIG. 2 illustrates a functional block diagram of a portion of a radio frequency (RF) front end circuit of a semiconductor die according to one implementation of the present application. As illustrated in FIG. 2, front end unit 205 includes cavities 206a, 206b, 206c and 206d coupled to radio frequency (RF) front end circuit 240 in semiconductor die 208. In the present implementation, cavities 206a, 206b, 206c and 206d may substantially correspond to cavities 106a, 106b, 106c and 106d, respectively, in FIGS. 1A and 1B. In the present implementation, semiconductor die 208 may correspond to semiconductor die 108a in FIGS. 1A and 1B. It is noted that the antennas probes and the plurality of RF shields as shown in FIGS. 1A and 1B are omitted from FIG. 2 for conceptual clarity.

In the present implementation, cavities 206a, 206b, 206c and 206d may be configured to receive RF signals from one or more commercial geostationary communication satellites, for example, which typically employ linearly polarized signals defined at the satellite with a horizontally-polarized (H) signal having its electric-field oriented parallel with the equatorial plane and a vertically-polarized (V) signal having its electric-field oriented perpendicular to the equatorial plane. As illustrated in FIG. 2, each of cavities 206a, 206b, 206c and 206d is configured to provide an H output and a V output to semiconductor die 208. For example, cavity 206a may provide a horizontally-polarized signal and a vertically-polarized signal through electrical connectors 210a-H and 210a-V, respectively, to RF front end circuit 240. Cavity 206b provides a horizontally-polarized signal and a vertically-polarized signal through electrical connectors 210b-H and 210b-V, respectively, to RF front end circuit 240. Cavity 206c provides a horizontally-polarized signal and a vertically-polarized signal through electrical connectors 210c-H and 210c-V, respectively, to RF front end circuit 240. Cavity 206d provides a horizontally-polarized signal and a vertically-polarized signal through electrical connectors 210d-H and 210d-V, respectively, to RF front end circuit 240. It is noted that the horizontal-polarization and vertical-polarization antenna probes and the plurality of RF shields similar to those shown in FIGS. 1A and 1B are omitted from FIG. 2 for conceptual clarity. It should be understood that the RF signals received from cavities 206a, 206b, 206c and 206d are provided to RF front end circuit 240 in semiconductor die 208 through the horizontal-polarization and vertical-polarization antenna probes, which are separated by the corresponding RF shields.

For example, a horizontally-polarized signal from cavity 206a may be provided to a receiving circuit through electrical connector 210a-H, where the receiving circuit includes low noise amplifier (LNA) 222a, phase shifter 224a and variable gain amplifier (VGA) 226a. As illustrated in FIG. 2, LNA 222a is configured to generate an output to phase shifter 224a, and phase shifter 224a is configured to generate an output to VGA 226a. In addition, a vertically-polarized signal from cavity 206a may be provided to a receiving circuit through electrical connector 210a-V, where the receiving circuit includes low noise amplifier (LNA) 222b, phase shifter 224b and variable gain amplifier (VGA) 226b. As illustrated in FIG. 2, LNA 222b is configured to generate an output to phase shifter 224b, and phase shifter 224b is configured to generate an output to VGA 226b.

Similarly, a horizontally-polarized signal from cavity 206b may be provided to a receiving circuit through electrical connector 210b-H, where the receiving circuit includes low noise amplifier (LNA) 222c, phase shifter 224c and variable gain amplifier (VGA) 226c. LNA 222c is configured to generate an output to phase shifter 224c, and phase shifter 224c is configured to generate an output to VGA 226c. In addition, a vertically-polarized signal from cavity 206b may be provided to a receiving circuit through electrical connector 210b-V, where the receiving circuit includes low noise amplifier (LNA) 222d, phase shifter 224d and variable gain amplifier (VGA) 226d. LNA 222d is configured to generate an output to phase shifter 224d, and phase shifter 224d is configured to generate an output to VGA 226d.

As further illustrated in FIG. 2, a horizontally-polarized signal from cavity 206c may be provided to a receiving circuit through electrical connector 210c-H, where the receiving circuit includes low noise amplifier (LNA) 222e, phase shifter 224e and variable gain amplifier (VGA) 226e, where LNA 222e is configured to generate an output to phase shifter 224e, and phase shifter 224e is configured to generate an output to VGA 226e. In addition, a vertically-polarized signal from cavity 206c may be provided to a receiving circuit through electrical connector 210c-V, where the receiving circuit includes low noise amplifier (LNA) 222f, phase shifter 224f and variable gain amplifier (VGA) 226f. LNA 222f is configured to generate an output to phase shifter 224f, and phase shifter 224f is configured to generate an output to VGA 226f. Similarly, a horizontally-polarized signal from cavity 206d may be provided to a receiving circuit through electrical connector 210d-H, where the receiving circuit includes low noise amplifier (LNA) 222g, phase shifter 224g and variable gain amplifier (VGA) 226g. LNA 222g is configured to generate an output to phase shifter 224g, and phase shifter 224g is configured to generate an output to VGA 226g. In addition, a vertically-polarized signal from cavity 206d may be provided to a receiving circuit through electrical connector 210d-V, where the receiving circuit includes low noise amplifier (LNA) 222h, phase shifter 224h and variable gain amplifier (VGA) 226h. LNA 222h is configured to generate an output to phase shifter 224h, and phase shifter 224h is configured to generate an output to VGA 226h.

As illustrated in FIG. 2, amplified and phase shifted horizontally-polarized signals H′207a from cavity 206a, H′207b from cavity 206b, H′207c from cavity 206c and H′207d from cavity 206d, are provided to summation block 228H, that is configured to sum all of the powers of the amplified and phase shifted horizontally-polarized signals, and combine all of the phases of the amplified and phase shifted horizontally-polarized signals, to provide horizontally-polarized combined signal 230H, for example, to a master chip (not explicitly shown in FIG. 2). Similarly, amplified and phase shifted vertically-polarized signals V′207a from cavity 206a, V′207b from cavity 206b, V′207c from cavity 206c and V′207d from cavity 206d, are provided to summation block 228V, that is configured to sum all of the powers of the amplified and phase shifted vertically-polarized signals, and combine all of the phases of the amplified and phase shifted vertically-polarized signals, to provide vertically-polarized combined signal 230V, for example, to the master chip (not explicitly shown in FIG. 2).

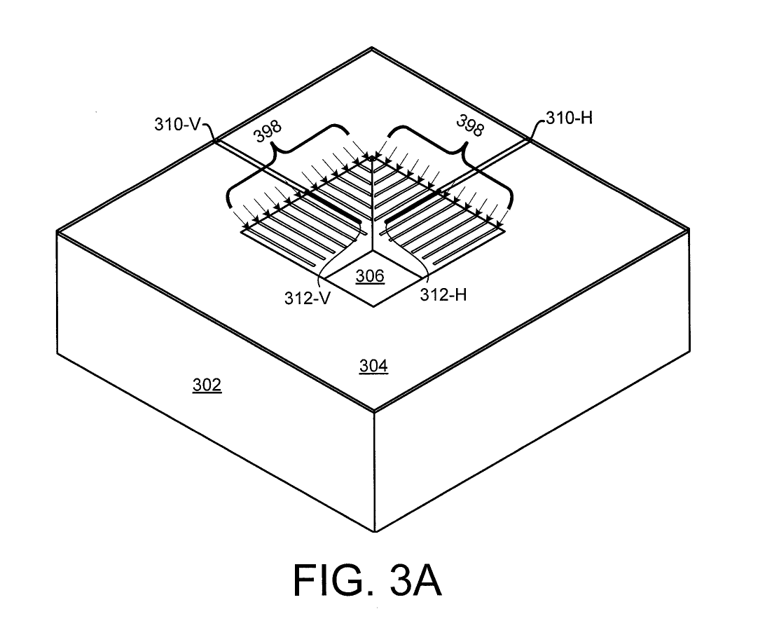

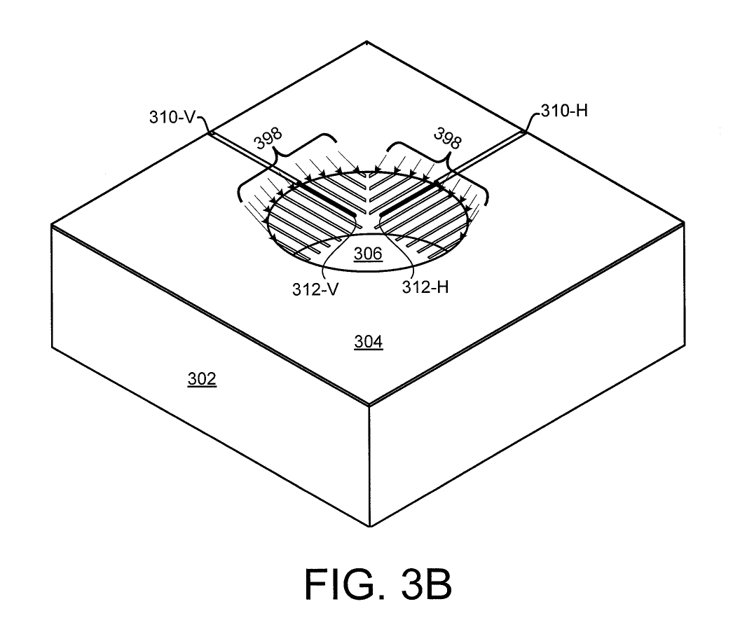

FIG. 3A illustrates a perspective view of a cavity of a phased array antenna panel according to one implementation of the present application. As shown in FIG. 3A, substrate 304 is situated over metallic base 302. Cavity 306 extends through substrate 304 into metallic base 302. In the present implementation, metallic base 302, substrate 304, and cavity 306 in FIG. 3A, may substantially correspond to metallic base 102, substrate 104, and any one of cavities 106, respectively, of phased array antenna panel 100A in FIG. 1A.

As illustrated in FIG. 3A, horizontal-polarization antenna probe 312-H and vertical-polarization antenna probe 312-V extend over cavity 306. Horizontal-polarization antenna probe 312-H is electrically and mechanically coupled electrical connector 310-H on substrate 304, while vertical-polarization antenna probe 312-V is electrically and mechanically coupled electrical connector 310-V on substrate 304. In the present implementation, electrical connectors 310-H and 310-V are microstrip feed lines on substrate 304. In one implementation, electrical connectors 310-H and 310-V may provide a horizontally-polarized signal and a vertically-polarized signal, respectively, to an RF front end circuit, such as RF front end circuit 240 on semiconductor die 208 in FIG. 2.

As illustrated in FIG. 3A, horizontal-polarization antenna probe 312-H and vertical-polarization antenna probe 312-V are perpendicular to each other, and have a number of RF shields 398 situated in the space between them. In the present implementation, a group of RF shields 398 is substantially parallel to horizontal-polarization antenna probe 312-H, while another group of RF shields 398 is substantially parallel to vertical-polarization antenna probe 312-V. As illustrated in FIG. 3A, RF shields 398 extend from the top edges of cavity 306 toward the center of the top opening of cavity 306. In one implementation, RF shields 398 may include conductive material, such as copper or nickel. In one implementation, RF shields 398 may be floating, i.e., not connected to any conducting path to ground or a voltage reference point. In another implementation, RF shields 398 may be electrically coupled to a DC potential, such as ground. RF shields 398 can reduce the coupling of electromagnetic waves between horizontal-polarization antenna probe 312-H and vertical-polarization antenna probe 312-V over cavity 306. As a result, a phased array antenna panel, such as phased array antenna panel 100A in FIG. 1A, may have reduced loss and increased bandwidth, gain, directivity and radiation pattern symmetry.

FIG. 3B illustrates a perspective view of a cavity of a phased array antenna panel according to one implementation of the present application. In the present implementation, metallic base 302, substrate 304, and cavity 306 in FIG. 3B, may substantially correspond to metallic base 102, substrate 104, and any one of cavities 106, respectively, of phased array antenna panel 100B in FIG. 1B. In the present implantation, metallic base 302, substrate 304, electrical connectors 310-H and 310-V, horizontal-polarization antenna probe 312-H, vertical-polarization antenna probe 312-V, and RF shields 398 may substantially correspond to metallic base 302, substrate 304, electrical connectors 310-H and 310-V, horizontal-polarization antenna probe 312-H, vertical-polarization antenna probe 312-V, and RF shields 398, respectively, in FIG. 3A.

In contrast to FIG. 3A, cavity 306 in FIG. 3B has a cylindrical shape with a substantially circular opening on the top side of cavity 306, whereas cavity 306 in FIG. 3A has a rectangular cuboid shape with a substantially square opening on the top side of cavity 306. In addition, in contrast to RF shields 398 that extend from the straight edges of the substantially square opening of cavity 306 in FIG. 3A, RF shields 398 in FIG. 3B extend from a substantially circular edge of cavity 306 toward the center of the substantially circular opening on the top side of cavity 306. In one implementation, RF shields 398 may be floating, i.e., not connected to any conducting path to ground or a voltage reference point. In another implementation, RF shields 398 may be electrically coupled to a DC potential, such as ground. RF shields 398 can reduce the coupling of electromagnetic waves between horizontal-polarization antenna probe 312-H and vertical-polarization antenna probe 312-V over cavity 306. As a result, a phased array antenna panel, such as phased array antenna panel 100B in FIG. 1B, may have reduced loss and increased bandwidth, gain, directivity and radiation pattern symmetry.

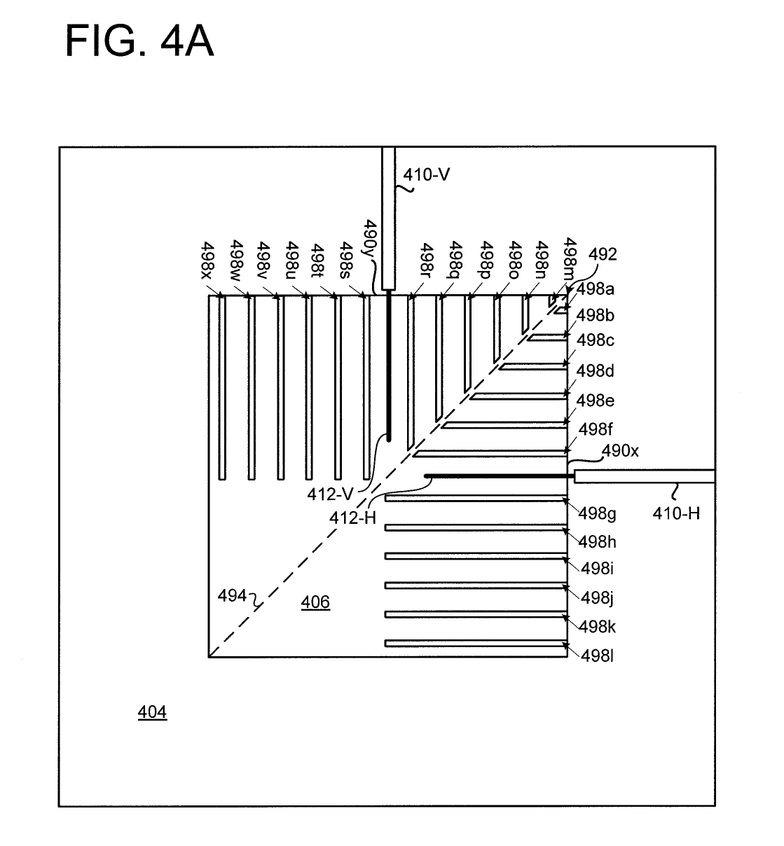

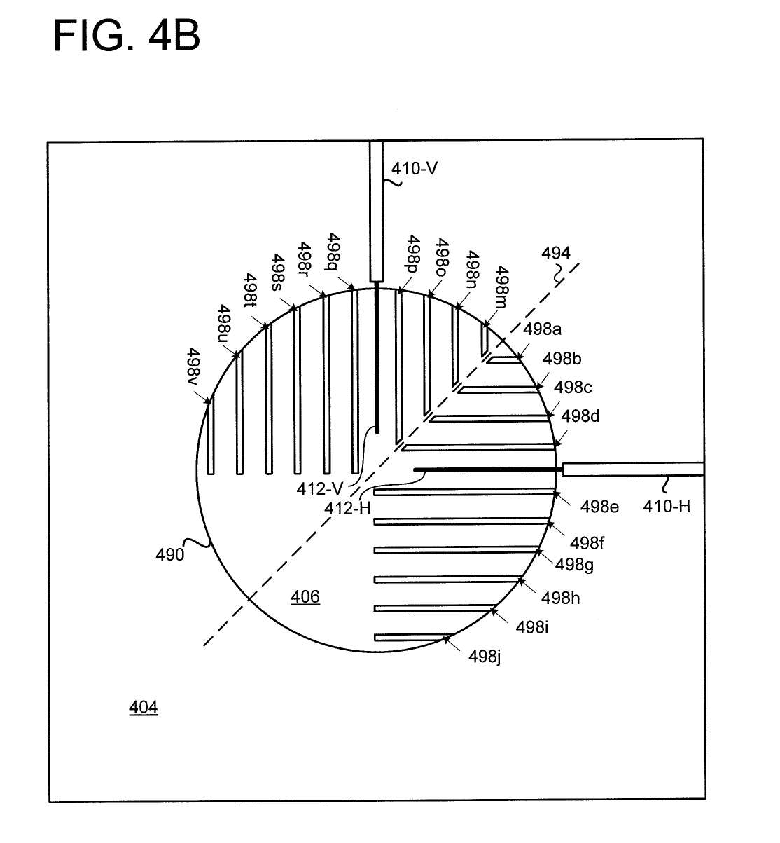

FIG. 4A illustrates a top plan view of a cavity of a phased array antenna panel according to one implementation of the present application. As shown in FIG. 4A, substrate 404 is situated over a metallic base (not explicitly shown in FIG. 4A), such as metallic base 302 in FIG. 3A. Cavity 406 extends through substrate 404 into the metallic base. Electrical connectors 410-H and 410-V are formed on substrate 404, and connected to horizontal-polarization antenna probe 412-H and vertical-polarization antenna probe 412-V, respectively. As illustrated in FIG. 4A, horizontal-polarization antenna probe 412-H and vertical-polarization antenna probe 412-V extend over cavity 406. RF shields 498a, 498b, 498c, 498d, 498e, 498f, 498g, 498h, 498i, 498j, 498k, 498l, 498m, 498n, 498o, 498p, 498q, 498r, 498s, 498t, 498u, 498v, 498w and 498x (hereinafter collectively referred to as RF shields 498) extend from the top edges of cavity 406 toward the center of the top opening of cavity 406. In the present implantation, substrate 404, cavity 406, electrical connectors 410-H and 410-V, horizontal-polarization antenna probe 412-H, vertical-polarization antenna probe 412-V, and RF shields 498 may substantially correspond to substrate 304, cavity 306, electrical connectors 310-H and 310-V, horizontal-polarization antenna probe 312-H, vertical-polarization antenna probe 312-V, and RF shields 398, respectively, in FIG. 3A.

As illustrated in FIG. 4A, cavity 406 has a rectangular cuboid shape with a substantially square opening. Horizontal-polarization antenna probe 412-H is substantially parallel to RF shields 498a, 498b, 498c, 498d, 498e, 498f, 498g, 498h, 498i, 498j, 498k and 498l, which extend from top edge 490x of the substantially square top opening of cavity 406. RF shields 498g, 498h, 498i, 498j, 498k and 498l are on one side of horizontal-polarization antenna probe 412-H, while RF shields 498a, 498b, 498c, 498d, 498e and 498f are on the other side of horizontal-polarization antenna probe 412-H. In the present implementation, RF shields 498g, 498h, 498i, 498j, 498k and 498l are substantially equally spaced, and substantially equal in length. RF shields 498f, 498e, 498d, 498c, 498b and 498a are also substantially equally spaced, but the lengths of RF shields 498f, 498e, 498d, 498c, 498b and 498a slowly taper along line 494 toward corner 492 of the substantially square top opening of cavity 406. In the present implementation, line 494 is approximately at a 45-degree angle with horizontal-polarization antenna probe 412-H and vertical-polarization antenna probe 412-V.

As further illustrated in FIG. 4A, vertical-polarization antenna probe 412-V is substantially parallel to RF shields 498m, 498n, 498o, 498p, 498q, 498r, 498s, 498t, 498u, 498v, 498w and 498x, which extend from top edge 490y of the substantially square top opening of cavity 406. RF shields 498s, 498t, 498u, 498v, 498w and 498x are on one side of vertical-polarization antenna probe 412-V, while RF shields 498m, 498n, 498o, 498p, 498q and 498r are on the other side of vertical-polarization antenna probe 412-V. In the present implementation, RF shields 498s, 498t, 498u, 498v, 498w and 498x are substantially equally spaced, and substantially equal in length. RF shields 498m, 498n, 498o, 498p, 498q and 498r are also substantially equally spaced, but the lengths of RF shields 498r, 498q, 498p, 498o, 498n and 498m slowly taper along line 494 toward corner 492 of the substantially square top opening of cavity 406.

RF shields 498 are configured to reduce the coupling of electromagnetic waves between horizontal-polarization antenna probe 412-H and vertical-polarization antenna probe 412-V over cavity 406. By way of example and without any limitation, for a phased array antenna panel (e.g., phased array antenna panel 100A in FIG. 1A) for example receiving RF signals at around 12 GHz, by utilizing RF shields 498 over each cavity, the phased array antenna panel may have an increased gain of approximately 7 dB, a reduced loss of approximately −20.8 dB, and an increased isolation between horizontal-polarized signals and vertical-polarized signals of approximately −21 dB. In addition, the phased array antenna panel can also achieve increased bandwidth, directivity and radiation pattern symmetry.

FIG. 4B illustrates a top plan view of a cavity of a phased array antenna panel according to one implementation of the present application. As shown in FIG. 4B, substrate 404 is situated over a metallic base (not explicitly shown in FIG. 4B), such as metallic base 302 in FIG. 3B. Cavity 406 extends through substrate 404 into the metallic base. Electrical connectors 410-H and 410-V are formed on substrate 404, and connected to horizontal-polarization antenna probe 412-H and vertical-polarization antenna probe 412-V, respectively. As illustrated in FIG. 4B, horizontal-polarization antenna probe 412-H and vertical-polarization antenna probe 412-V extend over cavity 406. RF shields 498a, 498b, 498c, 498d, 498e, 498f, 498g, 498h, 498i, 498j, 498m, 498n, 498o, 498p, 498q, 498r, 498s, 498t, 498u and 498v (hereinafter collectively referred to as RF shields 498) extend from the substantially circular top edge of cavity 406 toward the center of the top opening of cavity 406. In the present implantation, substrate 404, cavity 406, electrical connectors 410-H and 410-V, horizontal-polarization antenna probe 412-H, vertical-polarization antenna probe 412-V, and RF shields 498 may substantially correspond to substrate 304, cavity 306, electrical connectors 310-H and 310-V, horizontal-polarization antenna probe 312-H, vertical-polarization antenna probe 312-V, and RF shields 398, respectively, in FIG. 3B.

As illustrated in FIG. 4B, horizontal-polarization antenna probe 412-H is substantially parallel to RF shields 498a, 498b, 498c, 498d, 498e, 498f, 498g, 498h, 498i and 498j, which extend from top edge 490 of the substantially circular top opening of cavity 406. RF shields 498e, 498f, 498g, 498h, 498i and 498j are on one side of horizontal-polarization antenna probe 412-H, while RF shields 498a, 498b, 498c and 498d are on the other side of horizontal-polarization antenna probe 412-H. In the present implementation, RF shields 498e, 498f, 498g, 498h, 498i and 498j are substantially equally spaced, while the lengths of RF shields 498e, 498f, 498g, 498h, 498i and 498j vary as they are disposed along top edge 490 of the substantially circular top opening of cavity 406. RF shields 498d, 498c, 498b and 498a are also substantially equally spaced. While RF shields 498d, 498c, 498b and 498a are disposed along top edge 490 of the substantially circular top opening of cavity 406, the lengths of RF shields 498d, 498c, 498b and 498a also slowly taper along line 494 indicated over the substantially circular top opening of cavity 406. In the present implementation, line 494 is approximately at a 45-degree angle with horizontal-polarization antenna probe 412-H and vertical-polarization antenna probe 412-V.

As further illustrated in FIG. 4B, vertical-polarization antenna probe 412-V is substantially parallel to RF shields 498m, 498n, 498o, 498p, 498q, 498r, 498s, 498t, 498u and 498v, which extend from top edge 490 of the substantially circular top opening of cavity 406. RF shields 498q, 498r, 498s, 498t, 498u and 498v are on one side of vertical-polarization antenna probe 412-V, while RF shields 498m, 498n, 498o and 498p are on the other side of vertical-polarization antenna probe 412-V. In the present implementation, RF shields 498q, 498r, 498s, 498t, 498u and 498v are substantially equally spaced, while the lengths of RF shields 498q, 498r, 498s, 498t, 498u and 498v vary as they are disposed along top edge 490 of the substantially circular top opening of cavity 406. RF shields 498m, 498n, 498o and 498p are also substantially equally spaced. While RF shields 498m, 498n, 498o and 498p are disposed along top edge 490 of the substantially circular top opening of cavity 406, the lengths of RF shields 4.98p, 498o, 498n and 498m also slowly taper along line 494.

RF shields 498 can reduce the coupling of electromagnetic fields between horizontal-polarization antenna probe 412-H and vertical-polarization antenna probe 412-V over cavity 406. By utilizing RF shields 498 to separate horizontal-polarization antenna probe 412-H and vertical-polarization antenna probe 412-V, a phased array antenna panel, such as phased array antenna panel 100B in FIG. 1B, may have increased gain, bandwidth, directivity, radiation pattern symmetry, and isolation between horizontal-polarized signals and vertical-polarized signals. RF shields 498 over cavity 406 are also configured to reduce loss of the phased array antenna panel.

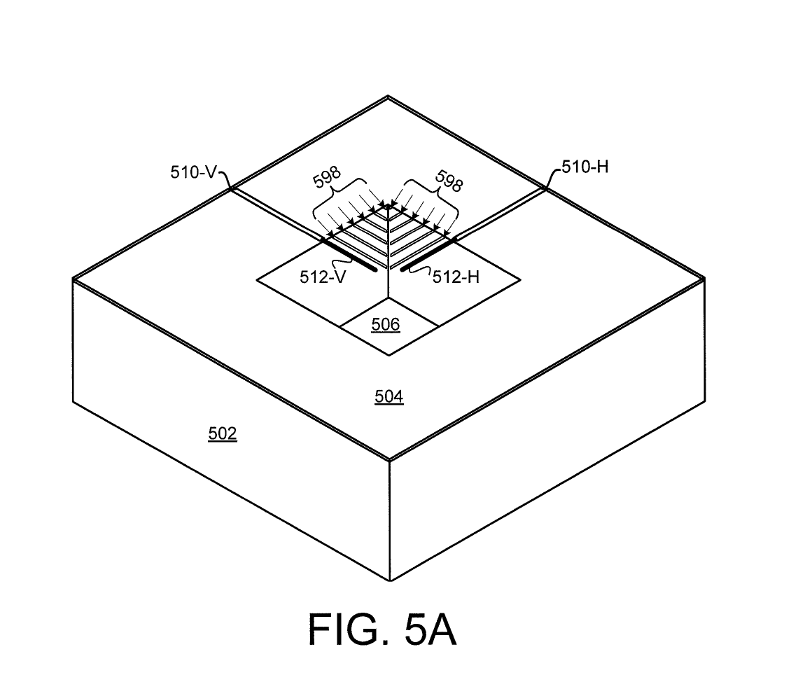

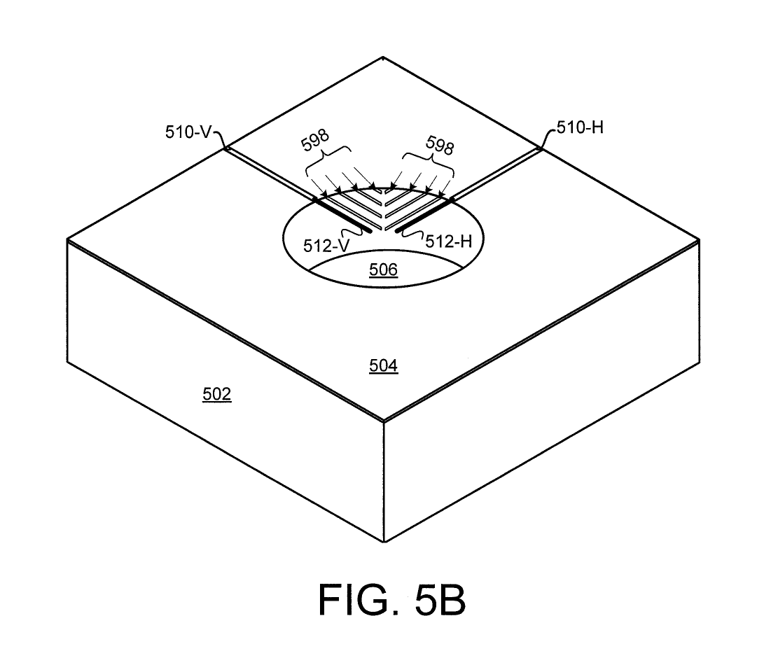

FIG. 5A illustrates a perspective view of a cavity of a phased array antenna panel according to one implementation of the present application. As shown in FIG. 5A, substrate 504 is situated over metallic base 502. Cavity 506 extends through substrate 504 into metallic base 502. As illustrated in FIG. 5A, horizontal-polarization antenna probe 512-H and vertical-polarization antenna probe 512-V extend over cavity 506. Horizontal-polarization antenna probe 512-H is electrically and mechanically coupled electrical connector 510-H on substrate 504, while vertical-polarization antenna probe 512-V is electrically and mechanically coupled electrical connector 510-V on substrate 504. In the present implementation, electrical connectors 510-H and 510-V are microstrip feed lines on substrate 504. In one implementation, electrical connectors 510-H and 510-V may provide a horizontally-polarized signal and a vertically-polarized signal, respectively, to an RF front end circuit, such as RF front end circuit 240 on semiconductor die 208 in FIG. 2. As illustrated in FIG. 5A, horizontal-polarization antenna probe 512-H and vertical-polarization antenna probe 512-V are perpendicular to each other, and have RF shields 598 situated between them.

In the present implementation, metallic base 502, substrate 504, cavity 506, electrical connectors 510-H and 510-V, horizontal-polarization antenna probe 512-H, vertical-polarization antenna probe 512-V, and RF shields 598 may substantially correspond to metallic base 302, substrate 304, cavity 306, electrical connectors 310-H and 310-V, horizontal-polarization antenna probe 312-H, vertical-polarization antenna probe 312-V, and RF shields 398 as shown in FIG. 3A. However, in contrast to RF shields 398 in FIG. 3A, RF shields 598 are disposed in the region between horizontal-polarization antenna probe 512-H and vertical-polarization antenna probe 512-V over cavity 506. Similar to RF shields 398 in FIG. 3A, RF shields 598 are also configured to reduce the coupling of electromagnetic waves transmitted or received by horizontal-polarization antenna probe 512-H and vertical-polarization antenna probe 512-V. As a result, a phased array antenna panel utilizing cavities, such as cavity 506 having RF shields 598, may have reduced loss and increased bandwidth, gain, directivity and radiation pattern symmetry.

FIG. 5B illustrates a perspective view of a cavity of a phased array antenna panel according to one implementation of the present application. As shown in FIG. 5B, substrate 504 is situated over metallic base 502. Cavity 506 extends through substrate 504 into metallic base 502. Horizontal-polarization antenna probe 512-H and vertical-polarization antenna probe 512-V extend over cavity 506. Horizontal-polarization antenna probe 512-H is electrically and mechanically coupled electrical connector 510-H on substrate 504, while vertical-polarization antenna probe 512-V is electrically and mechanically coupled electrical connector 510-V on substrate 504. In the present implementation, electrical connectors 510-H and 510-V are microstrip feed lines on substrate 504. In one implementation, electrical connectors 510-H and 510-V may provide a horizontally-polarized signal and a vertically-polarized signal, respectively, to an RF front end circuit, such as RF front end circuit 240 on semiconductor die 208 in FIG. 2. As illustrated in FIG. 5B, horizontal-polarization antenna probe 512-H and vertical-polarization antenna probe 512-V are perpendicular to each other, and have RF shields 598 situated between them.

In the present implementation, metallic base 502, substrate 504, cavity 506, electrical connectors 510-H and 510-V, horizontal-polarization antenna probe 512-H, vertical-polarization antenna probe 512-V, and RF shields 598 may substantially correspond to metallic base 302, substrate 304, cavity 306, electrical connectors 310-H and 310-V, horizontal-polarization antenna probe 312-H, vertical-polarization antenna probe 312-V, and RF shields 398 as shown in FIG. 3B. However, in contrast to RF shields 398 in FIG. 3B, RF shields 598 are disposed in the region between horizontal-polarization antenna probe 512-H and vertical-polarization antenna probe 512-V over cavity 506.

In the present implantation, metallic base 502, substrate 504, electrical connectors 510-H and 510-V, horizontal-polarization antenna probe 512-H, vertical-polarization antenna probe 512-V, and RF shields 598 may substantially correspond to metallic base 502, substrate 504, electrical connectors 510-H and 510-V, horizontal-polarization antenna probe 512-H, vertical-polarization antenna probe 512-V, and RF shields 598, respectively, as shown in FIG. 5A. In contrast to FIG. 5A, cavity 506 in FIG. 5B has a cylindrical shape with a substantially circular opening on the top side of cavity 506, whereas cavity 506 in FIG. 5A has a rectangular cuboid shape with a substantially square opening on the top side of cavity 506.

In addition, in contrast to RF shields 598 that extend from the straight edges of the substantially square opening of cavity 506 in FIG. 5A, RF shields 598 in FIG. 5B extend from a substantially circular edge of cavity 506 toward the center of the substantially circular opening on the top side of cavity 506. Similar to RF shields 398 in FIG. 3B and RF shields 598 in FIG. 5A, RF shields 598 are also configured to reduce the coupling of electromagnetic waves transmitted or received by horizontal-polarization antenna probe 512-H and vertical-polarization antenna probe 512-V. As a result, a phased array antenna panel utilizing cavities, such as cavity 506 having RF shields 598, may have reduced loss and increased bandwidth, gain, directivity and radiation pattern symmetry.

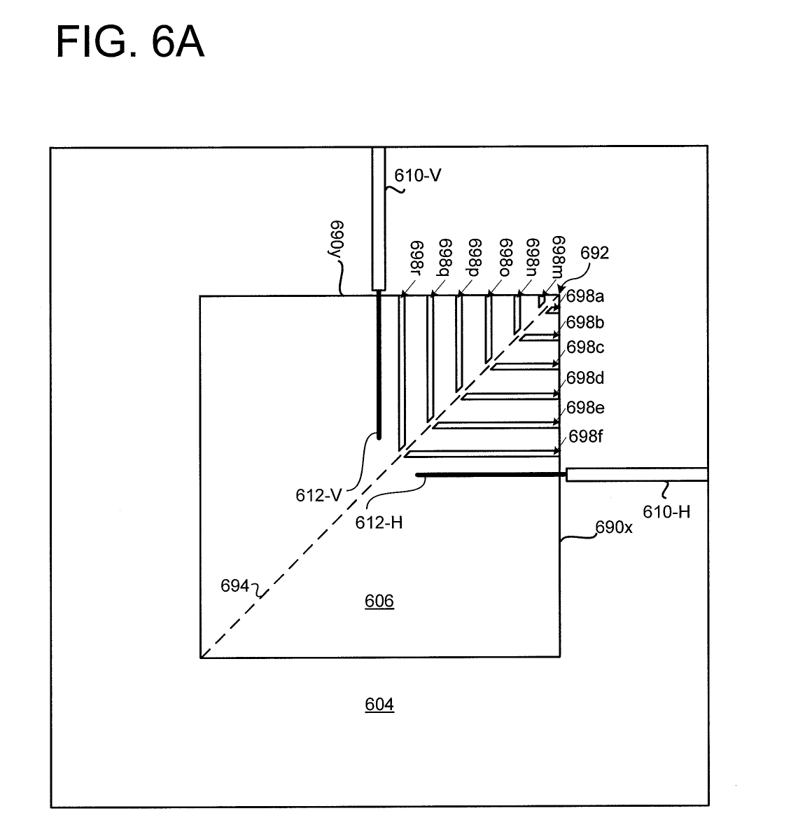

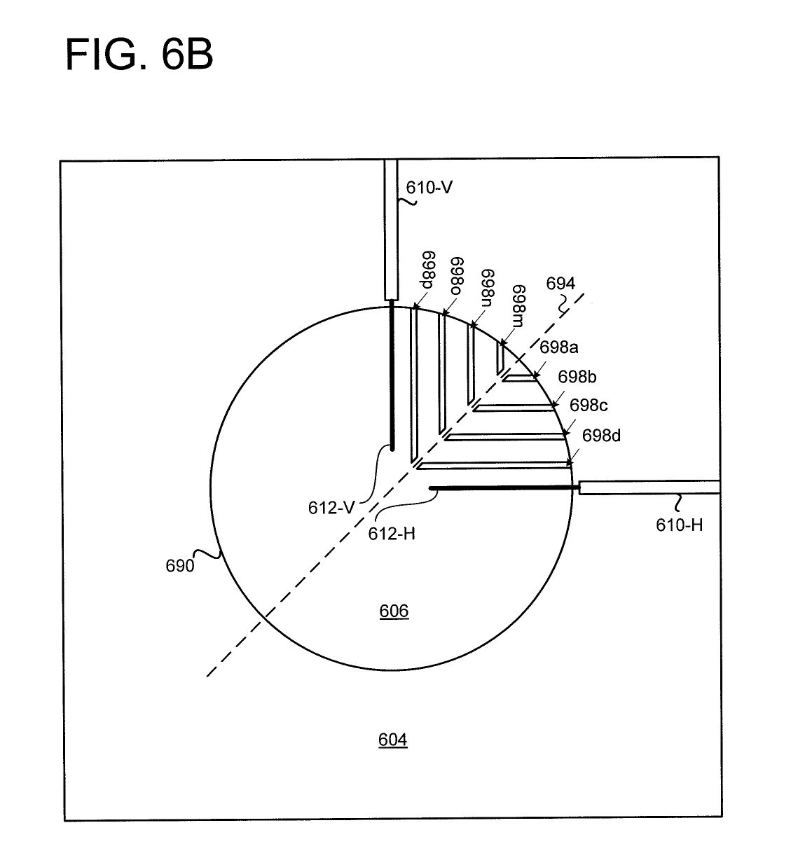

FIG. 6A illustrates a top plan view of a cavity of a phased array antenna panel according to one implementation of the present application. As shown in FIG. 6A, substrate 604 is situated over a metallic base (not explicitly shown in FIG. 6A), such as metallic base 502 in FIG. 5A. Cavity 606 extends through substrate 604 into the metallic base. Electrical connectors 610-H and 610-V are formed on substrate 604, and connected to horizontal-polarization antenna probe 612-H and vertical-polarization antenna probe 612-V, respectively. As illustrated in FIG. 6A, horizontal-polarization antenna probe 612-H and vertical-polarization antenna probe 612-V extend over cavity 606. RF shields 698a, 698b, 698c, 698d, 698e, 698f, 698m, 698n, 698o, 698p, 698q and 698r (hereinafter collectively referred to as RF shields 698) extend from the top edges of cavity 606 toward the center of the top opening of cavity 606. In the present implantation, substrate 604, cavity 606, electrical connectors 610-H and 610-V, horizontal-polarization antenna probe 612-H, vertical-polarization antenna probe 612-V, and RF shields 698 may substantially correspond to substrate 504, cavity 506, electrical connectors 510-H and 510-V, horizontal-polarization antenna probe 512-H, vertical-polarization antenna probe 512-V, and RF shields 598, respectively, in FIG. 5A.

As illustrated in FIG. 6A, cavity 606 has a rectangular cuboid shape with a substantially square opening. Horizontal-polarization antenna probe 612-H is substantially parallel to RF shields 698a, 698b, 698c, 698d, 698e and 698f, which extend from top edge 690x of the substantially square top opening of cavity 606. RF shields 698f, 698e, 698d, 698c, 698b and 698a are substantially equally spaced, and the lengths of RF shields 698f, 698e, 698d, 698c, 698b and 698a slowly taper along line 694 toward corner 692 of the substantially square top opening of cavity 606. In the present implementation, line 694 is approximately at a 45-degree angle with horizontal-polarization antenna probe 612-H and vertical-polarization antenna probe 612-V.

As further illustrated in FIG. 6A, vertical-polarization antenna probe 612-V is substantially parallel to RF shields 698m, 698n, 698o, 698p, 698q and 698r, which extend from top edge 690y of the substantially square top opening of cavity 606. RF shields 698m, 698n, 698o, 698p, 698q and 698r are substantially equally spaced, but the lengths of RF shields 698r, 698q, 698p, 698o, 698n and 698m slowly taper along line 694 toward corner 692 of the substantially square top opening of cavity 606.

In the present implementation, substrate 604, cavity 606, electrical connectors 610-H and 610-V, horizontal-polarization antenna probe 612-H, vertical-polarization antenna probe 612-V, and RF shields 698 may substantially correspond to substrate 404, cavity 406, electrical connectors 410-H and 410-V, horizontal-polarization antenna probe 412-H, vertical-polarization antenna probe 412-V, and RF shields 498, respectively, in FIG. 4A. However, in contrast to RF shields 498 in FIG. 4A, RF shields 698 are disposed in the region between horizontal-polarization antenna probe 612-H and vertical-polarization antenna probe 612-V. RF shields 698 are configured to reduce the coupling of electromagnetic waves transmitted or received by horizontal-polarization antenna probe 612-H and vertical-polarization antenna probe 612-V. As a result, a phased array antenna panel utilizing cavities, such as cavity 606 having RF shields 698, may have reduced loss and increased bandwidth, gain, directivity and radiation pattern symmetry.

FIG. 6B illustrates a top plan view of a cavity of a phased array antenna panel according to one implementation of the present application. As shown in FIG. 6B, substrate 604 is situated over a metallic base (not explicitly shown in FIG. 6B), such as metallic base 502 in FIG. 5B. Cavity 606 extends through substrate 604 into the metallic base. Electrical connectors 610-H and 610-V are formed on substrate 604, and connected to horizontal-polarization antenna probe 612-H and vertical-polarization antenna probe 612-V, respectively. As illustrated in FIG. 6B, horizontal-polarization antenna probe 612-H and vertical-polarization antenna probe 612-V extend over cavity 606. RF shields 698a, 698b, 698c, 698d, 698m, 698n, 698o and 698p (hereinafter collectively referred to as RF shields 698) extend from the substantially circular top edge of cavity 606 toward the center of the top opening of cavity 606. In the present implantation, substrate 604, cavity 606, electrical connectors 610-H and 610-V, horizontal-polarization antenna probe 612-H, vertical-polarization antenna probe 612-V, and RF shields 698 may substantially correspond to substrate 504, cavity 506, electrical connectors 510-H and 510-V, horizontal-polarization antenna probe 512-H, vertical-polarization antenna probe 512-V, and RF shields 598, respectively, as shown in FIG. 5B.

As illustrated in FIG. 6B, horizontal-polarization antenna probe 612-H is substantially parallel to RF shields 698a, 698b, 698c and 698d, which extend from top edge 690 of the substantially circular top opening of cavity 606. RF shields 698d, 698c, 698b and 698a are substantially equally spaced. RF shields 698d, 698c, 698b and 698a are disposed along top edge 690 of the substantially circular top opening of cavity 606. The lengths of RF shields 698d, 698c, 698b and 698a also slowly taper along line 694 indicated over the substantially circular top opening of cavity 606. In the present implementation, line 694 is approximately at a 45-degree angle with horizontal-polarization antenna probe 612-H and vertical-polarization antenna probe 612-V.

As further illustrated in FIG. 6B, vertical-polarization antenna probe 612-V is substantially parallel to RF shields 698m, 698n, 698o and 698p, which extend from top edge 690 of the substantially circular top opening of cavity 606. RF shields 698m, 698n, 698o and 698p are substantially equally spaced. RF shields 698m, 698n, 698o and 698p are disposed along top edge 690 of the substantially circular top opening of cavity 606. The lengths of RF shields 698p, 698o, 698n and 698m also slowly taper along line 694.

In the present implementation, substrate 604, cavity 606, electrical connectors 610-H and 610-V, horizontal-polarization antenna probe 612-H, vertical-polarization antenna probe 612-V, and RF shields 698a, 698b, 698c, 698d, 698m, 698n, 698o and 698p may substantially correspond to substrate 404, cavity 406, electrical connectors 410-H and 410-V, horizontal-polarization antenna probe 412-H, vertical-polarization antenna probe 412-V, and RF shields 498a, 498b, 498c, 498d, 498m, 498n, 498o and 498p as shown in FIG. 4B. However, in contrast to RF shields 498 in FIG. 4A, RF shields 698 are disposed only in the region between horizontal-polarization antenna probe 612-H and vertical-polarization antenna probe 612-V.

RF shields 698 are configured to reduce the coupling of electromagnetic waves transmitted or received by horizontal-polarization antenna probe 612-H and vertical-polarization antenna probe 612-V. As a result, a phased array antenna panel utilizing cavities, such as cavity 606 having RF shields 698, may have reduced loss and increased bandwidth, gain, directivity and radiation pattern symmetry.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A phased array antenna panel comprising:
a substrate over a metallic base;
a cavity in said substrate and said metallic base;
a plurality of antenna probes situated over said cavity;
wherein said plurality of antenna probes are separated by a plurality of RF shields.

2. The phased array antenna panel of claim 1 wherein said plurality of RF shields are configured to reduce coupling between said plurality of antenna probes.

3. The phased array antenna panel of claim 1 wherein said plurality of antenna probes comprise a pair of antenna probes.

4. The phased array antenna panel of claim 3 wherein some of said plurality of RF shields are parallel to a horizontal-polarization antenna probe of said pair of antenna probes.

5. The phased array antenna panel of claim 3 wherein some of said plurality of RF shields are parallel to a vertical-polarization antenna probe of said pair of antenna probes.

6. The phased array antenna panel of claim 3 wherein said pair of antenna probes comprises a horizontal-polarization antenna probe perpendicular to a vertical-polarization antenna probe.

7. The phased array antenna panel of claim 1 wherein said cavity has a rectangular cuboid shape.

8. The phased array antenna panel of claim 1 wherein said cavity has a cylindrical shape.

9. The phased array antenna panel of claim 1 wherein said cavity is an air cavity.

10. A phased array antenna panel comprising:
a substrate over a metallic base;
a cavity in said substrate and said metallic base;
a horizontal-polarization antenna probe, a vertical-polarization antenna probe and a plurality of RF shields over said cavity;
wherein said plurality of RF shields reduce coupling between said horizontal-polarization antenna probe and said vertical-polarization antenna probe.

11. The phased array antenna panel of claim 10 wherein some of said plurality of RF shields are parallel to said horizontal-polarization antenna probe.

12. The phased array antenna panel of claim 10 wherein some of said plurality of RF shields are parallel to said vertical-polarization antenna probe.

13. The phased array antenna panel of claim 10 wherein said horizontal-polarization antenna probe is perpendicular to said vertical-polarization antenna probe.

14. The phased array antenna panel of claim 10 wherein said cavity has a rectangular cuboid shape.

15. The phased array antenna panel of claim 10 wherein said cavity has a cylindrical shape.

16. The phased array antenna panel of claim 10 wherein said cavity is an air cavity.

17. A phased array antenna panel comprising:
a substrate over a metallic base;
a plurality of cavities in said substrate and said metallic base;
a semiconductor die situated over said substrate, said semiconductor die is coupled to at least two antenna probes over at least one of said plurality of cavities, said at least two antenna probes are separated by a plurality of RF shields;
wherein said semiconductor die is coupled to electrical connectors configured to carry combined horizontally-polarized signals and combined vertically-polarized signals.

18. The phased array antenna panel of claim 17 wherein said at least two antenna probes comprise at least one horizontal-polarization antenna probe and at least one vertical-polarization antenna probe.

19. The phased array antenna panel of claim 18 wherein said at least one horizontal-polarization antenna probe and said at least one vertical-polarization antenna probe provide input to phase shifters in a radio frequency (RF) front end circuit in said semiconductor die.

20. The phased array antenna panel of claim 18 wherein said at least one horizontal-polarization antenna probe and said at least one vertical-polarization antenna probe provide input to low noise amplifiers in a radio frequency (RF) front end circuit in said semiconductor die.
